(19) United States
(12) Patent Application Publication
(10) Pub. No.: US 2009/0313871 A1
(43) Pub. Date: Dec. 24, 2009

(54) Multi-point attaching product hang tag

(76) Inventor: Adam Merzon, Greenwich, CT (US)

Correspondence Address: Law Office of Stephen Cannavale LLC., 3 Hanlan Road, Caldwell, NJ, 07006, US

(21) Appl. No.: 12/319,240

(22) Filed: Jan. 5, 2009

Related U.S. Application Data
(60) Provisional application No. 61/010,025, filed on Jan. 4, 2008.

(51) Int. Cl. G09F 3/04

(52) U.S. Cl. 40/675; 40/299.01

(57) ABSTRACT

A product display tag comprising a front surface; and perpendicular side edges configured for attachment to a commercial product wherein the front surface is attached to the perpendicular side edges and a plurality of attachment sites for attaching said display tag to said product along the perpendicular side edges.

### RELATED APPLICATIONS

This application claims priority to U.S. Provisional Application No. 61/010,025, filed on Jan. 4, 2008, which is incorporated fully herein by reference.

### FIELD OF THE INVENTION

The present invention relates to a product hang tag, sell tag or sleeve, and more specifically to multi-point attaching hang tag with multi-page or multi-leave features and a method of making such a hang tag.

### BACKGROUND OF THE INVENTION

Point of sale presentation is often one of the most important yet underappreciated aspects of successful marketing of retail goods. When product features are easily visible and clearly displayed a potential buyer quickly and easily gains an understanding of the product, its advantages over a competitor's goods, and insight into unique product features which could prove useful in the purchasing decision. It is a well accepted principle that the retail display of products is a substantial factor in marketing success. Where product features, usefulness, advantages and the like can be easily discerned using an economical arrangement carried by the product, sales will typically be greater and returns less.

With certain products, providing an efficient and successful means to display the product and its key features has proved challenging. For example, some school or office products, such as binders or organizers, often have their most useful components and features inside the binder or organizer. Many of the most recent advances in these products have included new and useful internal compartments and attachments. These products, however, are usually packaged and displayed in stores in a manner such that the binder or organizer is packaged in a manner that keeps it closed; making it impossible for a prospective purchaser to see what is inside.

In certain instances, in order to allow a consumer to view the internal components of a binder or organizer, the binder or organizer is packaged, shelved and displayed in a manner such that that a user can manipulate and open the binder to view the internal components. Such an unrestricted display arrangement, however, is not desirable. The constant opening and manipulation of the product by consumers leads to a poor shelf life. As subsequent consumers repeatedly open and view the product, some units can become damaged or deteriorate to the point where they can no longer be offered for sale. Furthermore, loose internal components can be lost or separated from the commercial goods resulting in a high rate of returns and exchanges. Such damaged or deficient products can lead to a lower profit margin for both the retail store and the manufacturer of the product.

In order to prevent the constant consumer manipulation, some binders, organizers or other book like products have been packaged in a manner wherein the product cannot be easily opened at the retail store. In such circumstances, cardboard, paper, plastic or other known packaging material is wrapped around the product such that the product may not be easily opened. In other instances, the product may be packaged in a box, a clamshell package, sleeve or another type container. Such packaging, however, is also not desirable because the internal components of the packaged product are not easily visible to the consumer. As a result, the advantages of the product over others may not be fully comprehended or appreciated by the consumer.

Furthermore, some means of attaching hang tags are inadequate, since they are attached by only a single attaching device which can easily become unattached or damaged. Also such single attachment method tags generally are small in size and cannot present much information to the potential consumer.

What is needed is a display hang tag that is more versatile and which enables more information to be displayed in a given area. What is also needed is a multi-point attachment method having greater surface area that is of economical construction.

### SUMMARY OF THE INVENTION

The invention is directed to a product hang tag, sell tag or sleeve, and more specifically to multi-point attaching hang tag with multi-page or multi-leave features and a method of making such a hang tag.

The multi-point attaching hang-tag according to the present invention is configured to wrap partially around an article of sale, for example in one particular embodiment, a binder. The hand-tag according to the present invention presents to the potential consumer a large face sheet for displaying features of the product, with smaller perpendicular surface portions that may also be used for display of product information and also serve as anchor points for a plurality of attaching devices for attaching the hang-tag to the article of sale.

The hang tag according to the present invention may also have one or more overlay sheets that are attached to the hang tag face by an articulating spine. The spine of the multi-page overlay sheet is attached to a large face sheet which is configured to be attached to a binder or other product.

At least one surface of the face includes indicia relating to the product to which the multi-point attaching hang tag is attached, and may further include additional indicia relating to the product on the front and back of the articulating overlay sheet.

The invention is further directed to a method of manufacturing such a multi point attaching hang tag. The method includes forming two generally rectangular elongate gaps or interruptions in the sheet, defining a spine separating a pair of pages. Forming carried out in this method step leaves at least one bridge of sheet material connecting each page at least to the spine, if not one another. Forming preferably is performed by punching or stamping the sheet such as using a die, a press, a laser cutter, a fluid injection cutter, or another suitable cutting arrangement.

In a preferred method, the formed overlay sheets are laminated on both sides covering substantially the entire surface area of both sides of each page and the spine. Laminate material thus extends on both sides across the gap providing a region of less thickness and stiffness that defines a page hinge there along. Such a construction produces a durable, aesthetically attractive and yet economical hang tag multi-page overlay sheet.

Objects, features and advantages of the invention include a laminated multi point attaching product hang tag which may be equipped with a multi-page overlay sheet having a hinge that is mountable to a backing sheet of the hang tag that provides additional surface area for product description and a hang tag arrangement that is of economical construction, that is robust, that is reliable, that is long-lasting, that is more durable, that is of simple construction, and which is economical to apply and otherwise use.

Therefore, the present invention includes a product display tag comprising a front surface and perpendicular side edges configured for attachment to a commercial product wherein said front surface is attached to said perpendicular side edges and a plurality of attachment sites for attaching said display tag to said product along said perpendicular side edges.

Various other features and advantages of the present invention will also be made apparent from the following detailed description and the drawings.

### BRIEF DESCRIPTION OF THE DRAWINGS

FIG. 1 is a perspective view of the Multi-Point Attaching Product Hang Tag according to the present invention.

FIG. 2 is a perspective view of the Multi-Point Attaching Product Hang Tag according to the present invention attached to a binder.

FIG. 3 is a perspective view of an alternate embodiment of the Multi-Point Attaching Product Hang Tag according to the present invention attached to a binder.

### DETAILED DESCRIPTION OF THE INVENTION

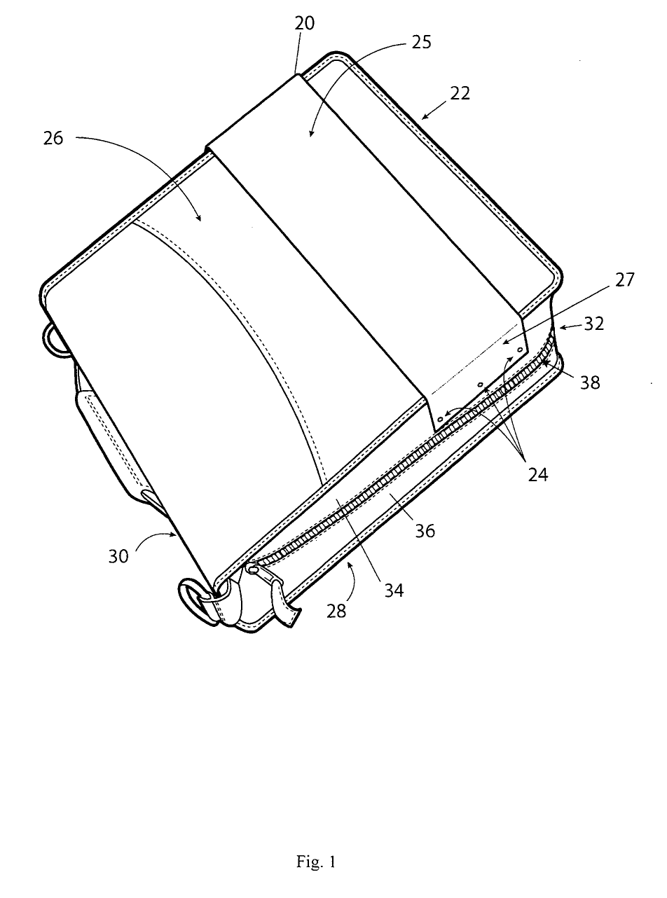

FIG. 1 illustrates a preferred embodiment of a product display multi point attaching hang tag 20 of the invention attached to a binder 22. Multi point attaching hang tag 20 is attached to binder 22 using plastic attachment tabs 24 inserted through the exterior of binder 22 and secured to the hang tag 20, such as is in a manner known in the art. It is understood that hang tag 20 could be attached to wide variety of products other than the illustrated binder 22 and the use of the inventive hang tag 20 with such other products is included in the scope of the present invention. As will become apparent from the description that follows, the particular features of the display multi point attaching hang tag 20 are particularly conducive for commercial display use with, for example, book-like products incorporating a spine interposed between a front and back cover and an opening therebetween.

Binder 22 is of a conventional type known in the art and is depicted in FIG. 1 in a closed position. Binder 22 includes a front cover 26, back cover 28 and a binder spine 30. If desired, the binder 22 can be equipped with a side wall 32 that extends partially circumferentially around the binder 22, such as from the spine 30 within the space defined between the front cover 26 and back cover 28. Front cover 26 and back cover 28 preferably are hingedly connected to spine 30. If desired, the binder 22 can be of spineless construction. As illustrated in FIG. 1, front cover 26 and back cover 28 are substantially aligned or overlap when binder 22 is closed.

Binder side wall 32 is generally comprised of an upper half 34 connected to the front cover 26 and lower half 36 connected to the back cover 28 of binder 22. Releasably connecting the halves 34, 36 of the side wall 32 is a zipper 38. Zipper 38 can be used to secure binder halves 34, 36 together thereby securing and keeping the contents housed within binder 22 together.

As can be seen in FIG. 1, the multi-point attaching hang tag according to the present invention has a front surface 25 which covers a portion of front cover 26 and is attached to the binder 22 by way of attachment tabs 24 which are secured to side wall 36 through perpendicular side edges 27 of multi point attaching hang tag 20. It should be pointed out that the attachment point for tabs 24 through the perpendicular side edge and perpendicular side edges 27 is on the top or front portion of side wall 36. In other words, not extending across zipper 38. In this way binder 22 can be opened while the multi point attaching hang tag is secured to the binder unlike a sleeve type display tag. In this way the multi point attaching hang tag according to the present invention is securely fastened, presents a large surface area to the potential purchaser and allows for the product to be manipulated by the potential purchaser.

Furthermore, it should be noted that front surface 25 provides a large surface area for the display of information and features related to the product. As can be seen, one of the benefits of the attachment method and configuration of the multi point attaching hang tag according to the present invention is that the front surface 25 display is readily viewable by the user because of the secure attachment to the binder 22. In this way the product information and features are more readily shown to the potential customer.

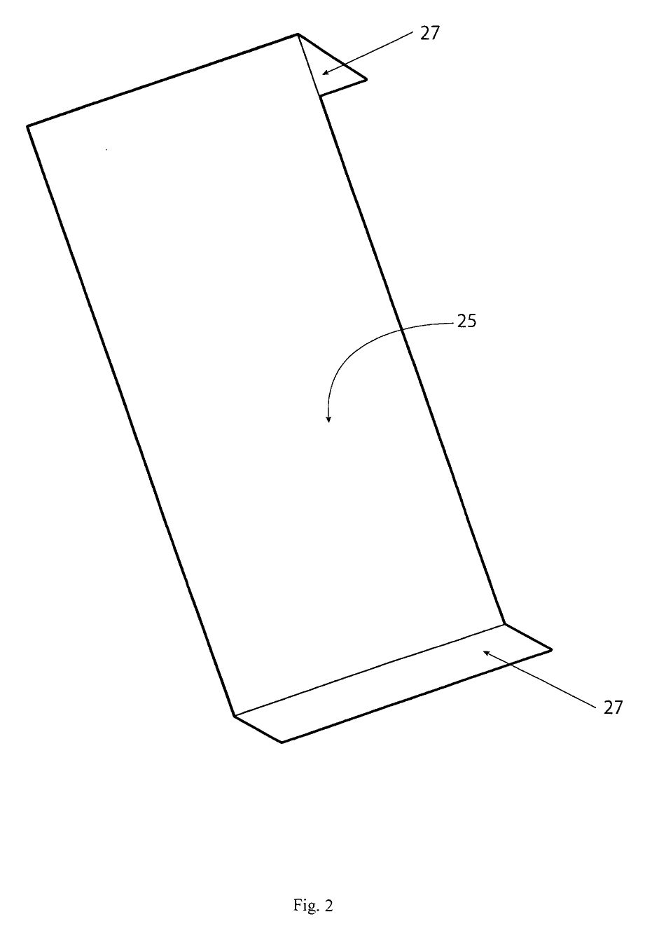

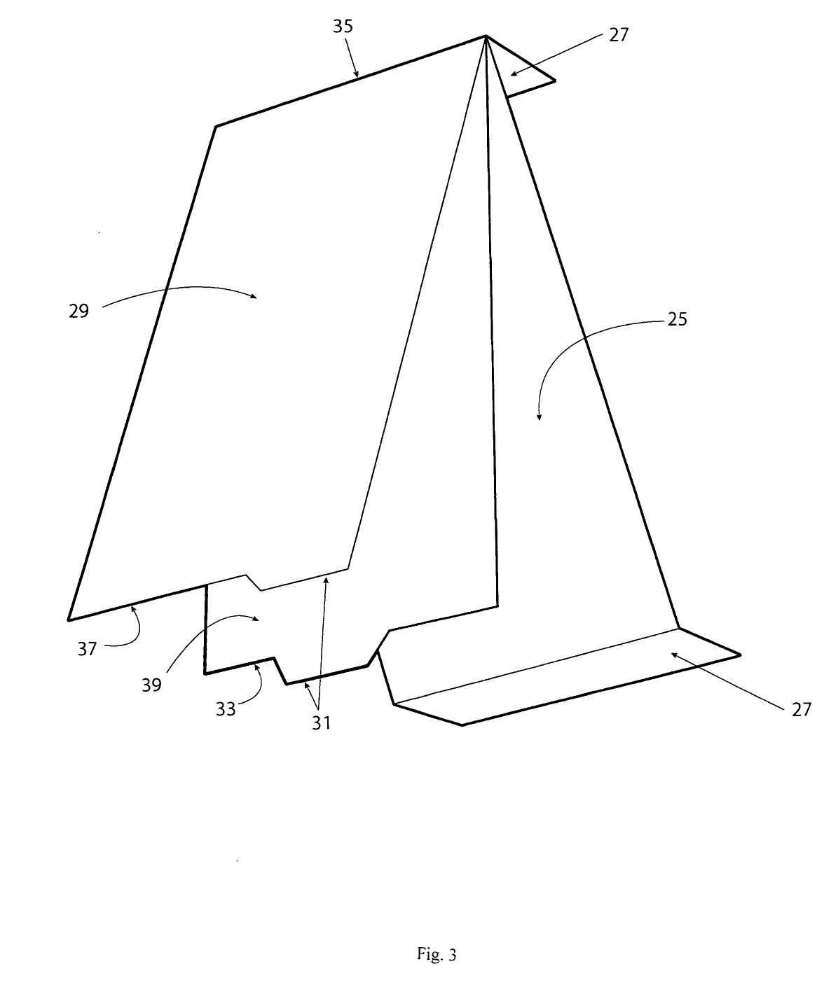

Referring additionally to FIGS. 2-3, the hang tag 20 preferably includes at least a front surface 25 and overlay sheets 29 and 39 mounted to the front surface 25. Front surface 25 preferably is a generally rectangular unitary member having perpendicular side edges 27. With specific reference to FIG. 3, the overlay sheets 29 and 39 are of generally the same size and shape as front surface 25 and pivots at a hinge 35. Overlay sheets 29 and 39 may also have an outwardly projecting tab 31, such as depicted in FIG. 3, which can be conveniently grasped by a prospective purchaser to manipulate the overlay sheets 29 and 39 from an closed to an open position and thereby easily view the front and back of the sheet. It should be noted that while two overlay sheets are depicted, any number of overlay sheets are possible. Additional overlay sheets may be incorporated to the multi-point attaching hang tag according to the present invention.

The hang tag 20 is formed of a sheet of material that preferably is of fibrous construction. Suitable backing sheet material includes card stock, thick paper stock, lightweight cardboard, another fibrous-based stock or sheet material, or the like that is formable by cutting, preferably die-cutting, laser cutting, or the like. The overlay sheet 29 preferably is of like construction and composition.

In one preferred embodiment, the sheet material has a thickness of at least 0.5 millimeter and typically has a thickness of between 0.5 millimeter and 2 millimeters. Referring once again to FIG. 1, the sheet material has at least one indicia carrying surface on which indicia is disposed thereon, such as, by printing or the like. Such indicia can take the form of advertising, logos, trademarks, graphics, instructions, feature listings, description text, etc.

In the preferred embodiment shown in FIGS. 1-3, the front surface 25 of the multi point attaching hang tag and the front surface of overlay sheet 29 and 39 and back surfaces 33 and 37 of the overlay sheet may contain indicia relating to the binder 20. Preferably, the front surface 25 of the multi point attaching hang tag and the front 29 and 39 and back 33 and 37 of the overlay sheets contain indicia relating to the product thereby maximizing the quantity of information conveyable using a minimum of hang tag surface area.

To increase durability and help preserve indicia, each sheet front and back surfaces in the preferred embodiment depicted in FIGS. 1-3 are preferably laminated with at least one layer of laminate material. Laminate material can be applied in a conventional manner, such as by bonding, using an adhesive, employing heat, or in another manner. Where indicia are applied, it preferably is done before any forming, e.g., cutting, and laminating is performed.

Although backing sheet multi point attaching hang tag front surface 25 is illustrated in the preferred embodiment as a generally rectangular member, it is understood that front surface 25 could be cut in any variety of shapes, depending on the desired application and associated product. In the illustrated embodiment, front surface 25 is cut in a manner so as to cover a portion of the binder 20 top cover 26, while still allowing internal access to the binder.

The overlay sheet 29 is mounted to the front multi point attaching hang tag 20 by an articulating hinge 35. With reference to FIG. 3, this construction enables either front surface 29 and 39 of the overlay sheet or back surface 33 and 37 to be turned by pivoting the page along its corresponding hinge region and as a result, a prospective purchaser can view indicia on either side of either page.

The hang tag 20 and overlay sheet 29 are all preferably cut from a single fibrous sheet, preferably paper card stock or the like. It is should be understood that the hang tag 20 and overlay sheet 29 pages may be cut in a wide variety of shapes and configurations depending on the particular application and all such modifications are contemplated as being within the scope of the present invention.

Graphics or indicia (not shown) are preferably printed on both the front side and backside of the hang tag 20 and overlay sheets 29 and 39. Preferably the hang tag 20 and overlay sheet 29 are laminated following an initial cutting stage as will be discussed in greater detail below.

The laminate provides a suitable coating for paper stock while allowing the hang tag 20 and overlay sheets 29 and 39 to be repeatedly flipped back and forth without cracking or tearing. Such laminate material can be, for example, composed of plastic, e.g., polyethylene, polypropylene, vinyl, etc., another type of polymeric material, a synthetic material of wholly different origin or another material suitable for laminate use.

It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

Various alternatives are contemplated as being within the scope of the following claims particularly pointing out and distinctly claiming the subject matter regarded as the invention.

What is claimed:

1. A product display tag comprising: a) a front surface; and b) perpendicular side edges configured for attachment to a commercial product wherein said front surface is attached to said perpendicular side edges; and c) a plurality of attachment sites for attaching said display tag to said product along said perpendicular side edges.

2. A product display tag according to claim 1 further comprising at least one overlay page hingedly connected to said front surface wherein said at least one overlay page may pivot from a closed to an opened position.

3. A product display tag according to claim 1 wherein said commercial product is a binder.

4. A product display tag according to claim 1 wherein said commercial product is a book.

5. A product display tag according to claim 1 wherein said commercial product has an articulating cover portion.

6. A product display tag according to claim 5 wherein said plurality of attachment sites are attached exclusively to said articulating cover portion.

7. A product display tag according to claim 1 wherein said front surface includes product information.

8. A product display tag according to claim 2 wherein said at least one overlay page includes a front display surface and a rear display surface.

9. A product display tag according to claim 8 wherein said front display surface includes product information.

10. A product display tag according to claim 8 wherein said rear display surface includes product display information.

11. A product display tag according to claim 2 wherein said overlay page includes a tab which extends beyond said perpendicular side edges.

12. A product display tag according to claim 2 further including a plurality of overlay pages.

13. A product display tag according to claim 1 wherein said product display tag includes a resilient flexible laminated surface covering.
